(19) United States
(12) Patent Application Publication
(10) Pub. No.: US 2025/0171244 A1
(43) Pub. Date: May 29, 2025

(54) CONDIMENT DISPENSING DEVICE FOR FOOD VENDING MACHINES

(71) Applicant: Leon LEYKIN, Pikesville, MD (US)

(72) Inventor: Leon LEYKIN, Pikesville, MD (US)

(21) Appl. No.: 18/963,900

(22) Filed: Nov. 29, 2024

Related U.S. Application Data
(60) Provisional application No. 63/603,168, filed on Nov. 28, 2023.

(51) Int. Cl. B65G 47/14

(52) U.S. Cl. CPC B65G 47/1492

(57) ABSTRACT

A condiment dispensing device is provided, which comprises a hollow housing removably mounted to a vertical mounting surface (e.g., of a food vending machine) and comprising a bottom opening. The housing accommodates a drive assembly and a dispensing belt. The drive assembly comprises two (upper and lower) gear sub-assemblies each comprising a shaft and a drive gear mounted thereon. The drive gear of the upper gear sub-assembly rotates via a timing belt driven by the gear motor. The dispensing belt is tensioned around the drive gears, and its outer surface has cleats, wherein each two adjacent cleats, together with the belt outer surface and the housing inner surface, a slot for a condiment packet. The drive gear of the lower gear sub-assembly is formed by tooth and star gears configured to jointly stop the dispensing belt each time at a position in which the opening is aligned with the slot.

### TECHNICAL FIELD

The present disclosure relates to the field of food vending machines. In particular, the present disclosure relates to a condiment dispensing device that may be part of a food vending machine or a stand-alone device.

### BACKGROUND OF THE INVENTION

Food vending machines are automated devices designed to dispense a variety of food items, such as snacks, hot dogs, sandwiches, even fresh meals, etc., upon payment. Users typically interact with the food vending machines by selecting a food item via buttons, a touchscreen, or a mobile application. The selected food item is then delivered to a user through a pick-up compartment or port. Some food vending machines may also work by keeping food items refrigerated or frozen and reheating them using a microwave or infrared heating system before dispensing them to users.

The food vending machines may be provided with condiment dispensing assemblies which are designed to deliver precise amounts of condiments, such as ketchup, mustard, mayonnaise, pickles, or sauces, upon user selection. The condiments may also be stored and delivered in individual packets each containing, e.g., a single serving. Such condiment packets prevent waste or overuse of condiments and allow the condiment to be sold per serving.

However, the existing condiment dispensing assemblies still face challenges, one of which is packet jamming that can be caused by irregular shapes, sizes or flexibility of condiment packets (due to which the condiment packets can get stuck, causing dispensing failures) and/or misalignment during their loading into the food vending machines.

Given the above, more engineering is required to solve the above-mentioned issues of the condiment dispensing assemblies.

### SUMMARY OF THE INVENTION

This summary is provided to introduce a selection of concepts in a simplified form that are further described below in the detailed description. This summary is not intended to identify key features of the present disclosure, nor is it intended to be used to limit the scope of the present disclosure.

It is an objective of the present disclosure to provide an improved condiment dispensing assembly that may be part of a food vending machine (e.g., hot dog vending machine) or a stand-alone device for any condiments or other products that may be transported using a cleated dispensing belt.

The objective above is achieved by the features of the independent claim in the appended claims. Further embodiments and examples are apparent from the dependent claims, the detailed description, and the accompanying drawings.

According to an aspect, a condiment dispensing device is provided. The condiment dispensing device comprises a hollow housing configured to be removably mounted to a vertical mounting surface (e.g., of a food vending machine). The hollow housing accommodates a drive assembly and a dispensing belt and comprises a bottom opening coupled to a customer pick-up port (which may also be part of the food vending machine).

The drive assembly comprises an upper gear sub-assembly, a lower gear sub-assembly, a timing belt and a gear motor. Each of the upper gear sub-assembly and the lower gear sub-assembly comprises a shaft, a drive gear mounted on the shaft and a pair of flanged rollers on either side of the drive gear. The gear motor is configured to cause the drive gear of the upper gear sub-assembly to rotate via the timing belt.

The dispensing belt is tensioned around the drive gears of the upper gear sub-assembly and the lower gear sub-assembly such that the dispensing belt is configured to move in response to rotation of the drive gear of the upper gear sub-assembly. The outer surface of the dispensing belt has a set of cleats evenly distributed thereon such that each two adjacent cleats of the set of cleats form, together with the outer surface of the dispensing belt (i.e., that part thereof which is between the two adjacent cleats) and an inner surface of the hollow housing, an individual slot or compartment for a condiment packet. The inner surface of the dispensing belt has teeth evenly distributed thereon such that grooves between the teeth of the inner surface of the dispensing belt match teeth of the drive gear of each of the upper gear sub-assembly and the lower sub-assembly.

The drive gear of the lower gear sub-assembly is configured as a dual gear comprising a tooth gear and a star gear attached to the tooth gear. The tooth gear and the star gear are configured to jointly stop the dispensing belt each time at a predefined position in which the bottom opening is aligned with one of the individual slots. The bottom opening is sized to cause the condiment packet to fall out of said one of the individual slots.

The dispensing device thus configured provides efficient (with no jam) dispensing of condiment packets to the proper position from which they can be delivered or transported to the customer pick-up port.

In one exemplary embodiment, the hollow housing comprises at least one vertical sight window extending opposite to the dispensing belt. The presence of the sight window(s) on the housing (on one or more sides thereof) may allow the device operator (e.g., the vending machine operator) to see the condiment inventory level in the dispensing device.

In one exemplary embodiment, the tooth gear is a T30 gear, and the star gear is a 7-point star gear. The combination of such tooth and star gears may provide a more precise alignment of the corresponding individual slot with the bottom opening of the hollow housing.

In one exemplary embodiment, the condiment dispensing device further comprises a position switch having an arm configured to run against a surface of the star gear. The position switch may be used for fine tuning adjustment of the dispensing belt. The combination of the star gear (e.g., the 7-point star gear) and the position switch operating in unison may provide a more precise alignment of the bottom opening with the corresponding individual slot—i.e., the predefined position in which the dispensing belt is stopped may be defined more accurately.

In one exemplary embodiment, the condiment dispensing device further comprises a tension adjustment assembly configured to cause the lower gear sub-assembly to vertically move inside the hollow housing. This additional assembly may provide proper tension of the dispensing belt.

Other features and advantages of the present disclosure will be apparent upon reading the following detailed description and reviewing the accompanying drawings.

### BRIEF DESCRIPTION OF DRAWINGS

The present disclosure is explained below with reference to the accompanying drawings in which:

FIG. 1 shows a schematic isometric view of a condiment dispensing device according to one exemplary embodiment;

FIG. 2 shows a schematic exploded view of the condiment dispensing device, which illustrates separately a hollow housing, a dispensing belt and a drive assembly;

FIG. 3 shows a schematic isometric view of the drive assembly used in the condiment dispensing device; and

FIG. 4 shows a schematic exploded view of the drive assembly.

### DETAILED DESCRIPTION OF THE INVENTION

Various embodiments of the present disclosure are further described in more detail with reference to the accompanying drawings. However, the present disclosure may be embodied in many other forms and should not be construed as limited to any certain structure or function discussed in the following description. In contrast, these embodiments are provided to make the description of the present disclosure detailed and complete.

According to the detailed description, it will be apparent to the ones skilled in the art that the scope of the present disclosure encompasses any embodiment thereof, which is disclosed herein, irrespective of whether this embodiment is implemented independently or in concert with any other embodiment of the present disclosure. For example, the device disclosed herein may be implemented in practice by using any numbers of the embodiments provided herein. Furthermore, it should be understood that any embodiment of the present disclosure may be implemented using one or more of the elements presented in the appended claims.

The word “exemplary” is used herein in the meaning of “used as an illustration”. Unless otherwise stated, any embodiment described herein as “exemplary” should not be construed as preferable or having an advantage over other embodiments.

Any positioning terminology, such as “left”, “right”, “top”, “bottom”, “above”, “below”, “over”, “under”, “upper”, “lower”, “horizontal”, “vertical”, etc., may be used herein for convenience to describe one element's or feature's relationship to one or more other elements or features in accordance with the figures. It should be apparent that the positioning terminology is intended to encompass different orientations of the apparatus disclosed herein, in addition to the orientation(s) depicted in the figures. As an example, if one imaginatively rotates the apparatus in the figures 90 degrees clockwise, elements or features described as “left” and “right” relative to other elements or features would then be oriented, respectively, “above” and “below” the other elements or features. Therefore, the positioning terminology used herein should not be construed as any limitation of the present disclosure.

The exemplary embodiments disclosed herein relate to a condiment dispensing device that may be part of a food vending machine or a stand-alone device. The dispensing device comprises a hollow housing removably mounted to a vertical mounting surface (e.g., of the food vending machine) and comprising a bottom opening. The hollow housing accommodates a drive assembly and a dispensing belt. The drive assembly is represented by an upper and lower gear sub-assembly, each of which comprises a shaft, a drive gear mounted on the shaft and a pair of flanged rollers on either side of the drive gear. The drive gear of the upper gear sub-assembly rotates via a timing belt driven by the gear motor. The dispensing belt is tensioned around the drive gears of the upper and lower gear sub-assemblies such that it is caused to move in response to the rotation of the drive gear of the upper gear sub-assembly. The outer surface of the dispensing belt is provided with cleats such that each two adjacent cleats form, together with the outer surface of the dispensing belt (i.e., that part thereof which is between the two adjacent cleats) and the inner surface of the hollow housing, an individual slot or compartment for a condiment packet. The inner surface of the dispensing belt has teeth and grooves therebetween, with the grooves matching teeth of the drive gear of each of the upper and lower gear sub-assemblies. The drive gear of the lower gear sub-assembly is configured as a dual gear comprising a tooth gear and a star gear which are configured to jointly stop the dispensing belt each time at a predefined position in which the bottom opening is aligned with one of the individual slots, thereby allowing the condiment packet to fall out of the dispensing belt.

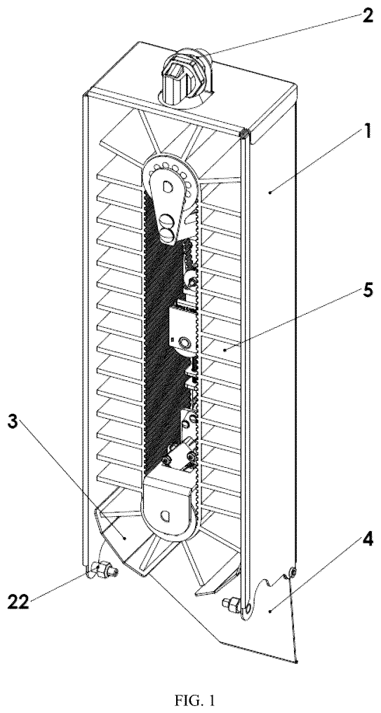

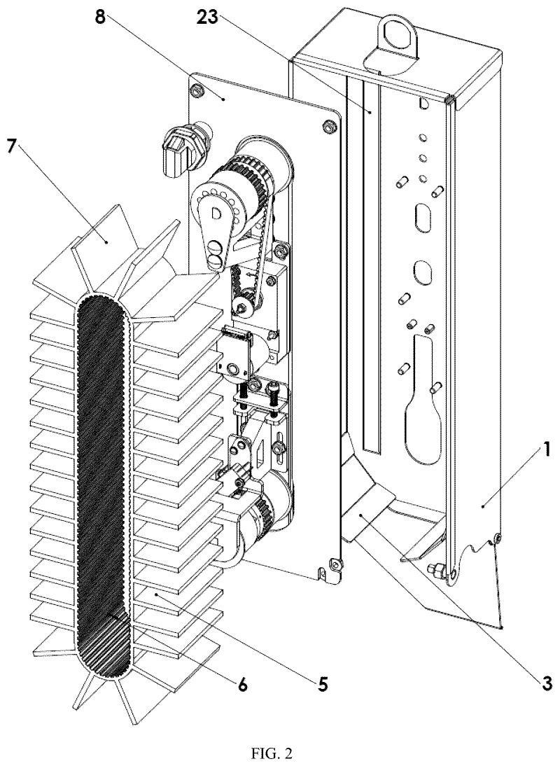

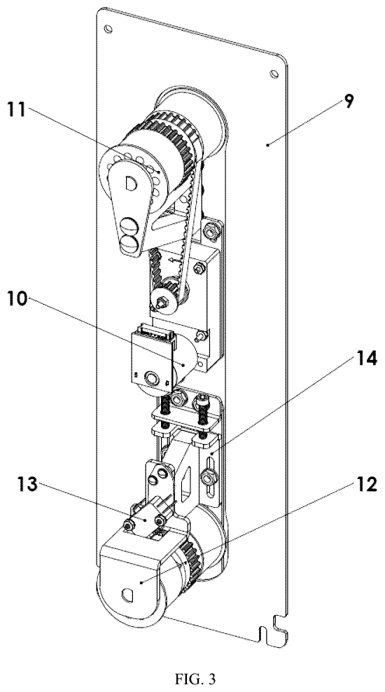

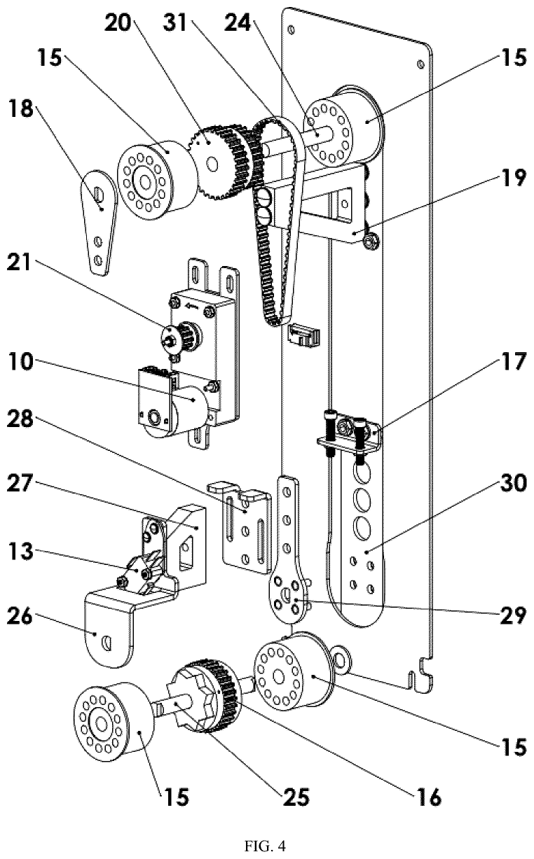

With reference to FIGS. 1-4, one exemplary embodiment of the condiment dispensing device will be now described in detail.

The condiment dispensing device is an assembly that can store and dispense (e.g., flexible) condiment packets on demand. The packets can be sized to correspond to a single serving or portion of one or more condiments. More specifically, the dispensing device comprises a dispensing belt 5 responsible for storing and dispensing the condiment packets around a surrounding hollow housing 1. The housing 1 has a bottom opening coupled or leading to a customer pick-up port (e.g., the one available in a food vending machine). As shown, the housing 1 may be curved to conform to the shape of the dispensing belt 5 at its bottom portion (see a curved section 3).

The condiment dispensing device can be mounted on the front door of a food dispensing machine or any vertical mounting surface (not shown) via a pivoting hinge 22 near the bottom of the housing 1. There can be a push button release mechanism 2 on the outer (e.g., top) surface of the housing 1 to allow for loading of condiment packets. After the front door of the vending machine or other protective door to the housing 1 is opened, the dispensing belt 5 is available for loading. A sight window 23 is incorporated into the housing 1 to allow the device operator or the vending machine operator to visually observe how many condiment packets are left in the condiment dispensing device. To begin the loading process, the housing 1 of the condiment dispensing device is unlatched using the push button release mechanism 2 and rotated downward, it may stop and rest against a triangular shaped hopper (only a part 4 of it is shown in FIG. 1) that may be mounted onto the food vending machine door or a stand-alone dispenser mounting plate. This hopper may collect dispensed condiment packets from multiple adjacent condiment dispensing devices and direct them to a single dispensing port for pick-up by a customer. The top of the hopper also provides a surface for the condiment dispensing device to rest in a roughly horizontal position, allowing the individual condiment packets to be easily placed into individual slots created by cleats 7 of the dispensing belt 5. The cleat 7 are evenly distributed on the outer surface of the dispensing belt 5. Each of the individual slots is formed by the two adjacent cleats 7, the outer dispensing belt surface between the two adjacent cleats 5, and the inner surface or wall of the housing 1. When the condiment dispensing device has been filled with the condiment packets, the housing 1 can be pivoted up until the push button release mechanism 2 latches, thereby securing the whole assembly into a vertical position.

The housing 1 also accommodates a drive assembly 9 attached to its inner surface or wall via a mounting plate 8. The drive assembly includes an upper gear sub-assembly 11, a lower gear sub-assembly 12, a timing belt 31 and a gear motor 10. The upper gear sub-assembly 11 includes a shaft 24, a drive gear 20 mounted on the shaft 24, and a pair of flanged rollers 15 on either side of the drive gear 20. The lower gear sub-assembly 12 includes a shaft 25, a drive gear 16 mounted on the shaft 25, and a pair of flanged rollers 15 on either side of the drive gear 16. The drive gear 20 is caused to rotate via the timing belt 31 driven by the gear motor 10. More specifically, the gear motor assembly includes an output gear shaft 21 driven by the gear motor 10, and the timing belt 31 is stretched around the shaft 21 and the drive gear 20. Thus, the gear motor 10 drives the timing belt 31 indirectly via the shaft 21, which in turn causes the drive gear 20 to rotate. The drive gear 20 has teeth and grooves therebetween, with the grooves matching the teeth of the timing belt 31.

The dispensing belt 5 is held in place and tensioned around the drive gears 16, 20 of the two (upper and lower) gear sub-assemblies 11, 12. The inner surface of the dispensing belt 5 is provided with evenly distributed teeth or ribs 6, and the grooves between the teeth 6 match the teeth of each of the drive gears 16, 20.

The position of the dispensing belt 5 is controlled by the lower gear sub-assembly which as such is a driven pulley assembly. As can be seen, the drive gear 16 of the lower gear sub-assembly is a dual gear that is composed by a tooth gear and a star gear. In this non-restrictive exemplary embodiment, the tooth gear is a T30 gear, and the star gear is a 7-point star gear. The relative position of the T30 gear and the 7-point star gear maintains a proper timing, so that the dispensing belt 5 stops at a correct position in which the condiment packets can fall out of the dispensing belt 5. The 7-point star gear can actuate a position switch 13 to determine when the dispensing belt 5 has advanced one full position (in which the bottom opening of the housing 1 is aligned with the corresponding slot). The position switch 13 is mounted on a tension adjustment assembly 14 to allow fine tuning adjustment of the dispensing belt 5. The tension adjustment assembly 14 comprises: a screw sub-assembly 17 (for the tension adjustment itself); a support plate 18 for the upper gear sub-assembly 11; a support stanchion 19 for the upper gear sub-assembly 11; a support bracket 26 for the lower gear sub-assembly 12; a support stanchion 27 for the lower gear sub-assembly 12; a mounting plate 28 on which the support stanchion 27 is mounted; a mounting plate 29 which is intended to support the lower gear sub-assembly 12 together with the elements 26-28; and a back clamping plate 30 to which all the aforesaid elements are attached.

It should be noted that the tension adjustment assembly 14 can allow the lower gear assembly 12 to perform a linear (vertical) movement so it can be positioned to give the dispensing belt 5 the optimum tension using the screw sub-assembly 17 prior to it being secured in position.

Although the exemplary embodiments of the present disclosure are described herein, it should be noted that any various changes and modifications could be made in the embodiments of the present disclosure, without departing from the scope of legal protection which is defined by the appended claims. In the appended claims, the word “comprising” does not exclude other elements or operations, and the indefinite article “a” or “an” does not exclude a plurality. The mere fact that certain measures are recited in mutually different dependent claims does not indicate that a combination of these measures may not be used to advantage.

1. A condiment dispensing device comprising:
a hollow housing configured to be removably mounted to a vertical mounting surface, the hollow housing comprising a bottom opening leading to a customer pick-up port;
a drive assembly arranged in the hollow housing, the drive assembly comprising an upper gear sub-assembly, a lower gear sub-assembly, a timing belt and a gear motor, each of the upper gear sub-assembly and the lower gear sub-assembly comprising a shaft, a drive gear mounted on the shaft and a pair of flanged rollers on either side of the drive gear, the gear motor being configured to cause the drive gear of the upper gear sub-assembly to rotate via the timing belt; and
a dispensing belt tensioned around the drive gears of the upper gear sub-assembly and the lower gear sub-assembly such that the dispensing belt is configured to move in response to rotation of the drive gear of the upper gear sub-assembly;
wherein the dispensing belt has an inner surface and an outer surface, the outer surface of the dispensing belt having a set of cleats evenly distributed thereon such that each two adjacent cleats of the set of cleats form, together with the outer surface of the dispensing belt and an inner surface of the hollow housing, an individual slot for a condiment packet;
wherein the inner surface of the dispensing belt has teeth evenly distributed thereon such that grooves between the teeth of the inner surface of the dispensing belt match teeth of the drive gear of each of the upper gear sub-assembly and the lower sub-assembly; and
wherein the drive gear of the lower gear sub-assembly is configured as a dual gear comprising a tooth gear and a star gear attached to the tooth gear, the tooth gear and the star gear being configured to jointly stop the dispensing belt each time at a predefined position in which the bottom opening is aligned with one of the individual slots, the bottom opening being sized to cause the condiment packet to fall out of said one of the individual slots.

2. The condiment dispensing device of claim 1, wherein the hollow housing comprises at least one vertical sight window extending along and opposite to the dispensing belt.

3. The condiment dispensing device of claim 1, wherein the tooth gear is a T30 gear, and the star gear is a 7-point star gear.

4. The condiment dispensing device of claim 1, further comprising a position switch having an arm configured to run against a surface of the star gear.

5. The condiment dispensing device of claim 1, further comprising a tension adjustment assembly configured to cause the lower gear sub-assembly to vertically move inside the hollow housing.
